(19) United States
(12) Patent Application Publication
(10) Pub. No.: US 2013/0003938 A1
(43) Pub. Date: Jan. 3, 2013

(54) X-RAY IMAGING SYSTEM

(75) Inventors: Koichiro Watanabe, Nasushiobara-shi (JP); Masaki Kobayashi, Otawara-shi (JP); Shumpei Oohashi, Otawarara-shi (JP)

(73) Assignees: TOSHIBA MEDICAL SYSTEMS CORPORATION, TOCHIGI (JP); KABUSHIKI KAISHA TOSHIBA, TOKYO (JP)

(21) Appl. No.: 13/634,912

(22) PCT Filed: Dec. 5, 2011
(86) PCT No.: PCT/JP11/78064

§ 371 Date: Sep. 14, 2012

(30) Foreign Application Priority Data
Dec. 20, 2010 (JP) 2010-282572

(51) Int. Cl. H05G 1/02

(52) U.S. Cl. 378/195

(57) ABSTRACT

In an X-ray imaging system a holding device holds an X-ray imaging unit that performs X-ray imaging of a subject, a bed supports a subject, and a driving unit moves the holding device and the bed. A position detector detects positions of the holding device and the bed either when X-ray imaging is performed and/or when the driving unit has not performed driving for a predetermined time or more. A memory stores positions of the holding device and the bed detected by the position detector in a time series. An operation unit selects positions of the holding device and the bed stored in time series in either a time-series sequence or a reverse time-series sequence. Based on instructions from the operation unit, the controller reads out detection results from the memory and drives the driving unit based on the detection results.

### FIELD OF THE INVENTION

The embodiments of the present invention are related to an X-ray imaging system.

### BACKGROUND OF THE INVENTION

An X-ray imaging system is a system that irradiates a subject with X-rays, detects X-rays that have passed through the subject, and configures images indicating the intensity of the detected X-rays.

X-ray imaging systems have an auto-positioning function. An auto-positioning function refers to a function such as the following. Specifically, multiple arbitrary positions of both a holding device that holds an X-ray tube, etc. and a bed on which the subject is placed are associated with arbitrary numbers and stored in advance. Then, with this function, when an operator inputs a desired number during an examination, the holding device and the bed are automatically arranged at the positions associated with the number.

Moreover, in IVR (Interventional Radiology), catheter manipulations and surgical treatment are performed in parallel, therefore, a therapeutic manipulations (hybrid operations) increase. With this manipulation, there is a strong wish to proceed with the manipulation by fixing the holding device and the bed at positions desired by the operator. Consequently, even when the positions of the holding device and the bed are temporarily changed for X-ray imaging, it is desirable to easily return them to positions desired by the operator. The auto-positioning function described above is also used for this purpose.

### PRIOR ART DOCUMENTS

### Patent Document

Patent Document 1: Japanese published unexamined application 2003-210447

### SUMMARY OF THE INVENTION

### Problem to be Solved by the Invention

In a conventional auto-positioning function, when storing arbitrary positions of the holding device and the bed, it is necessary to use switches or a number pad provided on the operation unit of the X-ray imaging system to input numbers corresponding to the arbitrary positions. Even when reproducing arbitrary positions that have been stored, it is necessary to input numbers in the operation unit. This numerical input is performed manually in either case. Consequently, it is difficult for an operator to perform numerical input operations while performing hybrid operations, etc.

Furthermore, there are countless varieties of positions of the holding device and the bed depending on the body type of the subject, the positions desired by the operator, or the region being imaged, etc. Consequently, the operator has to perform operations for storing each arbitrary position.

In the embodiments, to solve the above problems, configurations that are able to easily store and reproduce arbitrary positions of the holding device and the bed are described. In the following descriptions, the term “X-ray imaging” also includes “fluoroscopy” (low-dose irradiation in which imaging is not performed).

### Means of Solving the Problem

To solve the above problems, the X-ray imaging system according to one embodiment includes a holding device that holds an X-ray imaging unit that performs X-ray imaging of a subject, a bed on which the subject is placed, and a driving unit that moves the holding device and the bed. A position detector detects the positions of the holding device and the bed in at least one of either time when X-ray imaging is performed by the X-ray imaging unit or time when the driving unit has not performed driving for a predetermined time or more. A memory stores the positions of the holding device and the bed detected by the position detector in a time series. An operation unit selects positions of the holding device and the bed that are stored in a time series in either a time-series sequence or a reverse time-series sequence. Based on instructions from the operation unit, the controller reads out detection results from the memory and drives the driving unit based on the detection results.

Moreover, to solve the above problems, the X-ray imaging system according to one embodiment includes a holding device that holds an X-ray imaging unit that performs X-ray imaging of a subject, a bed on which the subject is placed, and a driving unit that moves the holding device and the bed. A position detector detects the positions of the holding device and the bed in time when X-ray imaging is performed by the X-ray imaging unit. A memory associates and stores detection results from the position detector with identifiers. An operation unit is also provided. Based on instructions from the operation unit, a controller reads out detection results from the memory and drives the driving unit based on the detection results.

### BRIEF DESCRIPTION OF THE DRAWINGS

FIG. 1 is a block diagram of an X-ray imaging system according to the first embodiment.

FIG. 2 is a flowchart showing memory operations of the X-ray imaging system according to the first embodiment.

FIG. 3 is a flowchart showing reproduction operations of the X-ray imaging system according to the first embodiment.

FIG. 4 is a diagram supplementing the descriptions of the flowchart of the reproduction operation according to the first embodiment.

FIG. 5 is a flowchart showing memory operations of an X-ray imaging system according to the second embodiment.

FIG. 6 is a flowchart showing reproduction operations of the X-ray imaging system according to the second embodiment.

### MODE FOR CARRYING OUT THE INVENTION

### First Embodiment

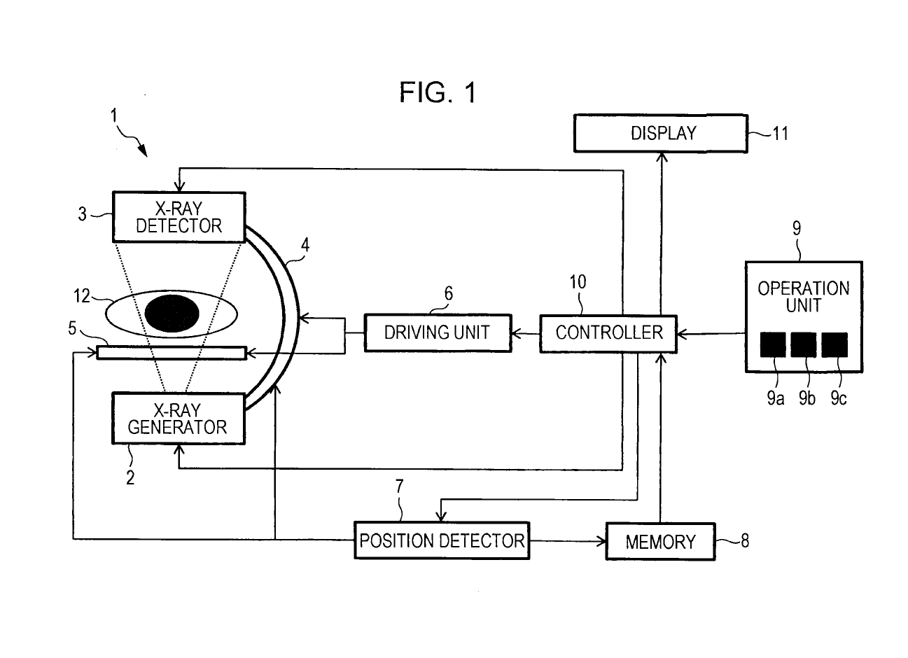

Configurations of an X-ray imaging system 1 according to the first embodiment are described with reference to FIGS. 1 through 4.

### (Device Configuration)

As shown in FIG. 1, the X-ray imaging system 1 includes an X-ray generator 2, an X-ray detector 3 a holding device 4 a bed 5, a driving unit 6, a position detector 7, a memory 8, an operation unit 9, a controller 10, and a display 11. During X-ray imaging, a subject 12 is arranged between the X-ray generator 2 and the X-ray detector 3.

The X-ray generator 2 has functions to generate X-rays and irradiate the region under examination of the subject 12 with the X-rays. The X-ray generator 2 includes a high-voltage generator (not illustrated) that generates a high voltage, and an X-ray tube (not illustrated) that generates X-rays when a high voltage from the high-voltage generator is applied.

The X-ray detector 3 has functions to detect X-rays that have been irradiated by the X-ray generator 2 in relation to the subject 12 and that have passed through the subject 12. The detected X-rays are converted into X-ray image information inside the X-ray detector 3. Then, the X-ray image information is transmitted via wiring (signal wire), etc. that is not illustrated to the memory 8 and is stored.

The holding device 4 has functions to hold the X-ray generator 2 and the X-ray detector 3. The holding device 4 has, for example, a C-shape referred to as a C-arm. The holding device 4 can be moved in the vicinity of the bed 5 by the driving unit 6. The X-ray generator 2 and the X-ray detector 3 are held by the holding device 4 to be provided at positions where they face each other. Consequently, it is possible to arrange the subject 12 between the X-ray generator 2 and the X-ray detector 3.

In the present embodiment, the X-ray generator 2 and the X-ray detector 3 configure the “X-ray imaging unit”. In other words, it can be said that the holding device 4 has functions to hold the X-ray imaging unit.

The bed 5 has functions to place the subject 12 undergoing X-ray imaging. The bed 5 can be moved by the driving unit 6 in the upward and downward, rightward and leftward, and forward and backward directions (the upward and downward, leftward and rightward, and forward and backward directions relative to the page in FIG. 1) while the subject 12 is placed.

The driving unit 6 has functions to drive the holding device 4 and the bed 5. The driving unit 6 is able to drive the holding device 4 and the bed 5 separately. That is, the driving unit 6 is able to drive the holding device 4 and the bed 5 simultaneously, and is also able to drive only one of either the holding device 4 or the bed 5.

The position detector 7 has functions to detect the positions of the holding device 4 and the bed 5 in time when X-ray imaging has been performed by the X-ray imaging unit. Position detection is performed by, for example, deciding on predetermined coordinate axes in advance and detecting where on those coordinate axes the holding device 4 and the bed 5 are positioned. It is also possible to perform position detection based on control signals sent from the controller 10 to the driving unit 6.

Determinations as to whether X-ray imaging has been performed can be confirmed based on whether the controller 10 has started performing control based on, for example, an input signal from the operation unit 9 to start X-ray imaging. Alternatively, it is also possible to detect whether X-ray imaging has been performed by detecting with a sensor, etc. whether or not the X-ray imaging unit has been operated.

In the present embodiment, the phrase “time when X-ray imaging is performed” refers to either time when the X-ray generator 2 generates X-rays relative to the subject 12 or time when X-rays that have passed through the subject 12 are detected by the X-ray detector 3.

The memory 8 has functions to store position detection results from the position detector 7 as well as detection results from the X-ray detector 3. In the present embodiment, each time position detection results are transmitted from the position detector 7, the memory 8 associates and stores the position detection results with predetermined identifiers. The identifiers are, for example, numbers (No. 1, No. 2, etc.) or the times when position detection was performed by the position detector 7. In other words, the identifiers are indicators that allow each position detection result to be identified. The identifiers of the present embodiment may be sequenceable (i.e., storable in time series) as described above.

In the present embodiment, the memory 8 has functions to associate and store X-ray images of the subject 12 obtained by the X-ray imaging unit with detection results detected by the position detector 7 with the X-ray images captured. This association is performed in the following manner, for example. If there has been an input from the operation unit 9 to start X-ray imaging, based on the input signals, the position detector 7 performs position detection of the holding device 4 and the bed 5 and transmits the results to the memory 8. At the same time, based on the input signals, the X-ray imaging unit starts X-ray imaging and transmits the X-ray image information to the memory 8. Then, in the memory 8, position detection results based on the same input signals are associated and stored with the X-ray image information.

The operation unit 9 is used for inputting the content of various operations of the X-ray imaging system 1, such as inputs of instructions to start or stop X-ray imaging by the X-ray imaging unit, or inputs of instructions to move the holding device 4 and the bed 5. As a result, it is possible to execute desired operations of the X-ray imaging system 1. In the present embodiment, the operation unit 9 is provided with at least an Auto-positioning switch 9a, an Undo switch 9b, and a Redo switch 9c. The operation unit 9 may also separately include an input means such as a mouse or a keyboard, etc.

When the Auto-positioning switch 9a is pressed, regardless of whether X-ray imaging has been performed, the current positions of the holding device 4 and the bed 5 are detected by the position detector 7. The positions are associated and stored with a predetermined identifier in the memory 8. In this way, by simply providing a single Auto-positioning switch 9a, it becomes possible to store positions of the holding device 4 and the bed 5 without operating various operation units, such as switches and number keys, multiple times as in conventional examples.

When the Undo switch 9b is pressed, the controller 10 reads out positions of the holding device 4 and the bed 5 stored in the memory 8 in a sequence (e.g., a time-series sequence) corresponding to the identifiers and causes the driving unit 6 to perform driving based on the detection results. As a result, it becomes possible to change the positions of the holding device 4 and the bed 5 in the sequence in which they were stored in the memory 8. In this way, by simply providing a single Undo switch 9b, it becomes possible to sequentially reproduce positions of the holding device 4 and the bed 5 without operating various operation units, such as switches and number keys, multiple times as in conventional examples. In the present embodiment, the Undo switch 9b configures the “first switch”.

When the Redo switch 9c is pressed, the controller 10 reads out positions of the holding device 4 and the bed 5 stored in the memory 8 in the reverse sequence of the sequence corresponding to the identifiers (e.g., in a reverse time-series sequence) and causes the driving unit 6 to drive based on the detection results. As a result, it becomes possible to change the positions of the holding device 4 and the bed 5 in the reverse sequence of the sequence in which they are stored in the memory 8. In this way, by simply providing a single Redo switch 9c, it becomes possible to sequentially reproduce positions of the holding device 4 and the bed 5 without operating various operation units, such as switches and number keys, multiple times as in conventional examples. In the present embodiment, the Redo switch 9c configures the “second switch”.

Controls performed by the controller 10 in accordance with the pressing of the Undo switch 9b or the Redo switch 9c are not limited to reading out positions of the holding device 4 and the bed 5 in sequences corresponding to the identifiers. For example, when the Undo switch 9b is pressed m number of times, the controller 10 may perform control to drive the driving unit 6 to be arranged at the positions of the holding device 4 and the bed 5 corresponding to the mth identifier without going through the positions of the holding device 4 and the bed 5 corresponding to the first through (m−1)th identifiers.

The controller 10 has functions to control operations of each configuration of the X-ray imaging system 1, such as the X-ray generator 2, the X-ray detector 3, and the driving unit 6. The controller 10 is able to start and stop control of each configuration based on inputs, etc. from the operation unit 9.

The display 11 has functions to display the results of X-ray imaging (i.e., X-ray images) or information related to position detection stored in the memory 8. The display 11 is composed of a display device such as, for example, a monitor. In the present embodiment, the display 11 is described as part of the X-ray imaging system 1, but the present invention is not limited to this. For example, X-ray images, etc. may be displayed on a computer monitor provided separately from the X-ray imaging system 1.

### (Memory Operations of the X-Ray Imaging System 1)

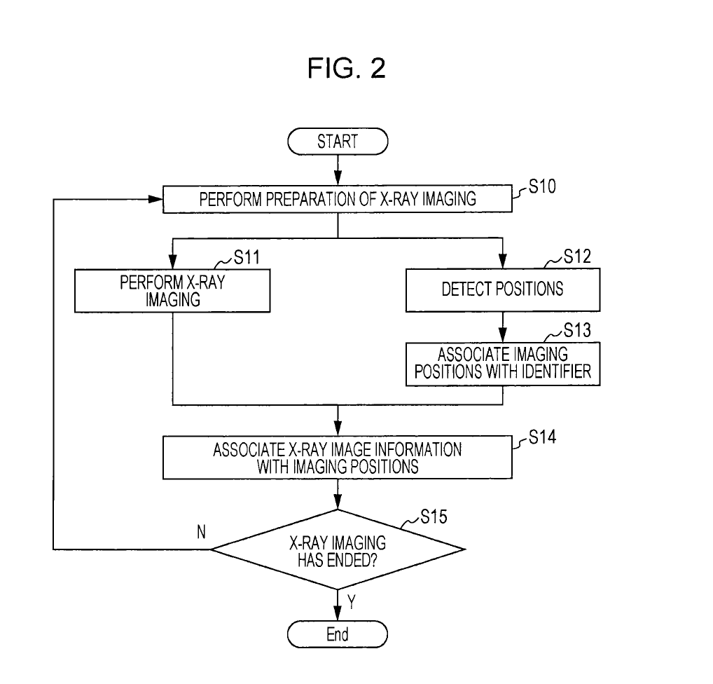

Next, memory operations of the X-ray imaging system 1 according to the present embodiment are described with reference to FIG. 2. This description assumes that the Auto-positioning switch 9a described above will not be pressed during the following memory operations.

First, the subject 12 is placed on the bed 5. Then, the operator operates the operation unit 9 and moves the holding device 4 and the bed 5 to the desired positions (i.e., positions suitable for imaging). In this way, preparations are made to be able to perform X-ray imaging (S10).

Next, when an input to perform X-ray imaging is made from the operation unit 9, the X-ray generator 2 irradiates the subject 12 with X-rays. Then, the X-ray detector 3 detects X-rays that have passed through the subject 12 and forms X-ray image information based on the X-rays (S11). The X-ray image information is transmitted to the memory 8.

Moreover, when an input to perform X-ray imaging is made from the operation unit 9, the position detector 7 detects the positions (hereinafter also referred to as “imaging positions”) of the holding device 4 and the bed 5 in time when the input is made (S12). The results of the position detection are transmitted to the memory 8. The steps of S11 and S12 are executed almost simultaneously by the input as a trigger signal from the operation unit 9.

The memory 8 associates and stores the imaging positions detected in S12 with an identifier (S13). In the present embodiment, as the identifier indicating the imaging positions related to the first round of imaging, “No. 1” is used. The identifiers indicating the imaging positions related to the second and third through nth rounds are, in order, No. 2 and No. 3 through to No. n.

The memory 8 associates and stores the X-ray image information captured in S11 with the imaging positions detected in S12 (S14). This storage is performed by associating the X-ray image information obtained based on the input signals to start the first round of imaging from the operation unit 9 with the detected imaging positions. Either S13 or S14 may be performed first. They may also be performed simultaneously.

As a result of performing the processes up to S14, the X-ray image information is associated with the identifier of S13.

Then, to perform X-ray imaging using a different position or angle, etc., the operations of S10 through S14 are repeated (if the result of S15 is “N”). In other words, the holding device 4 and the bed 5 are moved and X-ray imaging and position detection are performed again.

If X-ray imaging has ended (e.g., if there is no instruction to start X-ray imaging from the operation unit 9, or if an instruction to end X-ray imaging has been issued) (if the result of S15 is “Y”), the storage process of the memory 8 is stopped by the controller 10.

In this way, by performing multiple rounds of X-ray imaging, position detection results corresponding to that number of rounds are stored in the memory 8.

### (Reproduction Operations of the X-Ray Imaging System 1)

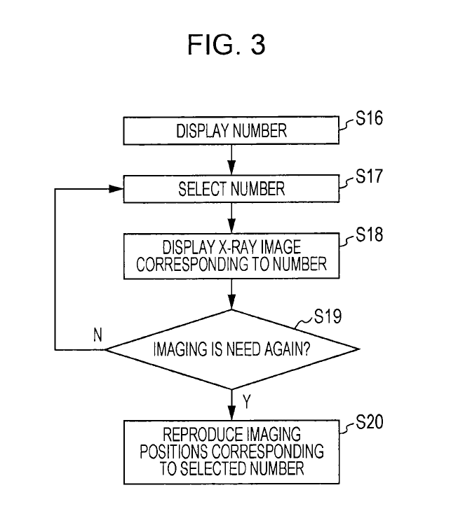

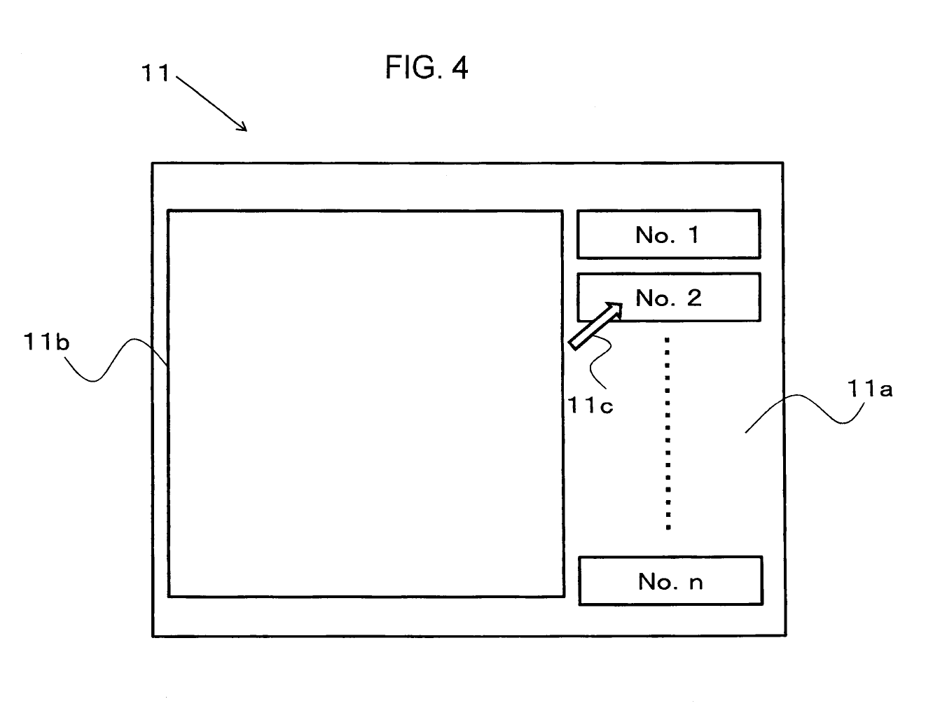

Next, reproduction operations of the X-ray imaging system 1 according to the present embodiment are described with reference to FIGS. 3 and 4. In the following descriptions, it shall be assumed that in the previous memory operations, n rounds of imaging have been performed and detection results of n number of imaging positions to which the identifiers No. 1 through No. n have been attached are stored in the memory 8. The following descriptions assume a situation in which one wishes to perform imaging with the holding device 4 and the bed 5 arranged in the same arrangement as in one of the n rounds of imaging performed previously (e.g., if it is unclear whether desired images have been captured due to movement of the subject 12 during imaging).

First, based on inputs of the operation unit 9, etc., the controller 10 displays numbers from No. 1 to No. n in a display region 11a of the display 11 (S16; FIG. 4). The items being displayed are not limited to numbers. For example, the times when X-ray imaging was performed, or data representing the imaging positions, etc. may be displayed.

Next, the operator uses the operation unit 9, etc. (e.g., by operating a pointing device 11c displayed on the display 11 using a mouse) to select a number (S17). As a result, in a display region 11b of the display 11, an X-ray image corresponding to that number is displayed (S18; FIG. 4).

The operator observes the X-ray image and determines whether it is an image that they wish to capture again.

When imaging is to be performed again (if the result in S19 is “Y”), as a result of, for example, the Undo switch 9b or the Redo switch 9c being pressed while a number is selected, the controller 10 controls the operations of the driving unit 6 so as to read out and reproduce (reproduce by skipping other numbers) the imaging positions corresponding to the selected number from the memory 8 instead of implementing the normal sequential reproduction (S20). The switch being pressed may also be, for example, the Auto-positioning switch 9a.

When none of the numbers displayed on the display 11 has been selected, the Undo switch 9b and the Redo switch 9c execute the functions described above. That is, each time the Undo switch 9b is pressed while no number has been selected, the controller 10 controls the driving unit 6 so as to sequentially move the holding device 4 and the bed 5 from the imaging positions corresponding to No. 1 to the imaging positions corresponding to No. n. At this time, it is also possible to display X-ray images corresponding to those numbers in the display region 11b.

On the other hand, if the image being displayed is not an image for which imaging is to be performed again (if the result in S19 is “N”), the operation unit 9, etc. is operated to select a different number.

### Operational Effects of the First Embodiment

In the present embodiment, the X-ray imaging system 1 includes the holding device 4 that holds the X-ray imaging unit that performs X-ray imaging of the subject 12, the bed 5 on which the subject 12 is placed, and the driving unit 6 that drives the holding device 4 and the bed 5. The position detector 7 has functions to detect the positions of the holding device 4 and the bed 5 when X-ray imaging is performed by the X-ray imaging unit. The memory 8 has functions to associate and store detection results from the position detector 7 with identifiers (numbers, etc.). Furthermore, the X-ray imaging system 1 of the present embodiment includes the controller 10 that, based on instructions from the operation unit 9, reads out detection results from the memory 8 and causes the driving unit 6 to perform driving based on the detection results.

Consequently, it is possible to easily store and reproduce arbitrary positions of the holding device 4 and the bed 5 using X-ray imaging as a trigger.

Moreover, in the present embodiment, the memory 8 is able to associate and store X-ray images of the subject 12 obtained by the X-ray imaging unit with detection results detected by the position detector 7 with the X-ray images captured.

Consequently, when reproducing positions of the holding device 4 and the bed 5, because it is possible to refer to the X-ray images, it is easy to select arbitrary positions.

In the present embodiment, the operation unit 9 includes the Undo switch 9b (first switch) for instructing the controller 10 to perform controls to read out detection results stored in the memory 8 in the sequence corresponding to the identifiers and drive the driving unit 6 based on the detection results. Moreover, the operation unit 9 includes the Redo switch 9c (second switch) for instructing the controller 10 to perform controls to read out detection results stored in the memory 8 in the reverse sequence of the sequence corresponding to the identifiers and drive the driving unit 6 based on the detection results.

Consequently, when sequentially reproducing multiple imaging positions of the holding device 4 and the bed 5, because it is no longer necessary to input a number each time one changes the imaging positions, it is easy to reproduce arbitrary positions of the holding device 4 and the bed 5.

### Second Embodiment

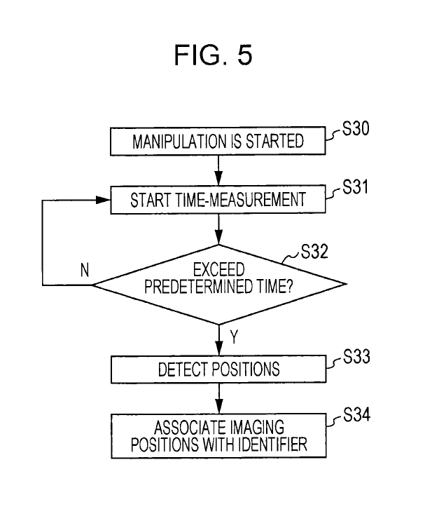

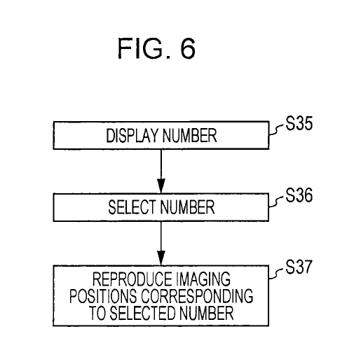

Next, the configurations of the X-ray imaging system 1 according to the second embodiment are described with reference to FIGS. 5 and 6. In the present embodiment, because there are also many configurations similar to those of the first embodiment, the description focuses on configurations that are different.

When performing a hybrid manipulation, normally, the holding device 4 and the bed 5 are fixed at positions desired by the operator and the manipulation is performed. On the other hand, there are cases in which the positions of the holding device 4 and the bed 5 are changed temporarily for X-ray imaging. In such a case, after performing X-ray imaging, it is desirable to be able to easily return the positions to the positions desired by the operator.

In the present embodiment, configurations enabling the holding device 4 and the bed 5 to be easily returned to positions desired by the operator in this way are described.

(Device Configuration)

As in the first embodiment, the X-ray imaging system 1 according to the present embodiment includes the X-ray generator 2, the X-ray detector 3, the holding device 4, the bed 5, the driving unit 6, the position detector 7, the memory 8, the operation unit 9, the controller 10, and the display 11.

The X-ray generator 2, the X-ray detector 3, the holding device 4, the bed 5, the driving unit 6, the operation unit 9, and the controller 10 have similar functions as in the first embodiment, and therefore, detailed descriptions are omitted.

In the present embodiment, the position detector 7 has functions to detect the positions of the holding device 4 and the bed 5 when the driving unit 6 has not performed driving for a predetermined time or more. As in the first embodiment, position detection is performed by, for example, deciding on predetermined coordinate axes and detecting where on those coordinate axes the holding device 4 and the bed 5 are positioned.

The determination as to whether the driving unit 6 has not performed driving for a predetermined time or more can be confirmed by determining whether, for example, a predetermined time has passed after the controller 10 stopped operational control of the driving unit 6. Specifically, upon detecting that the controller 10 has stopped operational control of the driving unit 6, the position detector 7 starts time-measurement. When the time-measurement exceeds a predetermined time, position detection is performed by the position detector 7.

The predetermined time can be input with each examination via the operation unit 9, etc. The predetermined time is determined based on, for example, the mean time of a past operation.

It is also possible to provide sensors to the holding device 4 and the bed 5 and confirm that the driving unit 6 has not performed driving when the sensors do not detect and driving of the holding device 4 or the bed 5 for a predetermined time or more.

The memory 8 has functions to record position detection results from the position detector 7. In the present embodiment, position detection results and X-ray images are not associated and stored together.

The display 11 has functions to display images captured during a hybrid operation as well as information related to position detection stored in the memory 8.

### (Memory Operations of the X-Ray Imaging System 1)

Next, memory operations of the X-ray imaging system 1 according to the present embodiment are described with reference to FIG. 5. In the following memory operations, it shall be assumed that the Auto-positioning switch 9a described above will not be pressed.

First, the subject 12 is placed on the bed 5. Then, the operator operates the operation unit 9 and moves the holding device 4 and the bed 5 to the desired positions (i.e., positions suitable for the hybrid operation). In this way, preparations are made to perform the hybrid operation. Then, the operator starts the manipulation (S30).

In S30, when there is no more movement of the holding device 4 and the bed 5 (i.e., when operation control of the driving unit 6 by the controller 10 is stopped), the position detector 7 starts time-measurement of the stopped movement (S31). When operation control of the driving unit 6 by the controller 10 starts during the time-measurement, the measured time is reset. Then, when operation control of the driving unit 6 by the controller 10 is stopped, time-measurement is started again.

Then, if the measured time of S31 exceeds a predetermined time (if the response in S32 is “Y”), the position detector 7 detects the positions of the holding device 4 and the bed 5 at that time (S33).

On the other hand, if the measured time of S31 does not exceed a predetermined time (if the response in S32 is “N”), time-measurement by the position detector 7 is continued.

The memory 8 associates and stores the positions detected in S33 with an identifier (S34). In the present embodiment, as the identifier indicating the position information detected in the first round, “No. 1” is used. The identifiers indicating the position information detected in the second and third though nth rounds are “No 2” and “No. 3” through “No. n”.

### (Reproduction Operations of the X-Ray Imaging System 1)

Next, reproduction operations of the X-ray imaging system 1 are described with reference to FIG. 6. In the following descriptions, it shall be assumed that in the previous memory operations, n rounds of position detection have been performed and n items of position detection results of the holding device 4 and the bed 5 from No. 1 through No. n are stored in the memory 8.

In the present embodiment, a case in which, as a result of moving the holding device 4 and the bed 5 and performing X-ray imaging of the subject 12, the operator wishes to restart the manipulation using the state in which the third round of position detection was performed is described.

First, based on inputs of the operation unit 9, etc., the controller 10 displays numbers from “No. 1” through “No. n” in the display region 11a of the display 11 (S35).

Next, using the operation unit 9, etc., the operator selects “No. 3”, for example (S36).

Then, when the number has been selected, by pressing the Undo switch 9b or the Redo switch 9c, for example, the controller 10 controls operation of the driving unit 6 so as to read out and reproduce (reproduce by skipping other numbers) the imaging positions corresponding to the selected number (S37).

### Operational Effects of the Second Embodiment

In the present embodiment, the X-ray imaging system 1 includes: the holding device 4 that holds the X-ray imaging unit that performs X-ray imaging of the subject 12; the bed 5 on which the subject 12 is placed; and the driving unit 6 that moves the holding device 4 and the bed 5. The position detector 7 has functions to detect the positions of the holding device 4 and the bed 5 when the driving unit 6 has not performed driving for a predetermined time or more. The memory 8 has functions to associate and store detection results from the position detector 7 with identifiers. Furthermore, the X-ray imaging system 1 of the present embodiment includes the controller 10 that, based on operational instructions from the operation unit 9, reads out detection results from the memory 8 and causes the driving unit 6 to perform driving based on the detection results.

Consequently, it is possible to easily store and reproduce arbitrary positions of the holding device 4 and the bed 5 using the fact that the driving unit 6 has not operated for a predetermined time as a trigger.

### Common Matters of Each Embodiment

The configurations described in the first embodiment and the second embodiment can be combined as appropriate.

For example, it is also possible to set the trigger for performing position detection with the position detector 7 as the drive states of both the X-ray imaging and the driving unit 6. Even if the conditions for performing position detection are increased in this way, it is possible to easily store arbitrary positions of the holding device 4 and the bed 5 by using the configurations of the embodiments.

It is also possible to associate patient IDs with the information stored in the memory 8. Because it is possible to easily reproduce positions of the holding device 4 and the bed 5 from previous examinations by associating patient IDs in this manner, when performing multiple rounds of examinations, etc. on a single patient, it is possible to accelerate the imaging, etc.

Several embodiments of the present invention have been described, but these embodiments are disclosed as examples and are not intended to limit the scope of the invention. These new embodiments can be carried out in various other modes, and various omissions, substitutions, and changes can be made without departing from the substance of the invention. These embodiments and their variations are included in the scope and substance of the invention, and are also included in a scope equivalent to that of the invention described in the scope of patent claims.

### EXPLANATION OF SYMBOLS

1: X-ray imaging system
2: X-ray generator
3: X-ray detector
4: Holding device
5: Bed
6: Driving unit
7: Position detector
8: Memory
9: Operation unit
10: Controller
11: Display
12: Subject

1. An X-ray imaging system comprising a holding device that holds an X-ray imaging unit that performs X-ray imaging of a subject, a bed on which the subject is placed, and a driving unit that moves the holding device and the bed, further comprising:
a position detector configured to detect the positions of the holding device and the bed in at least one of either time when X-ray imaging is performed by the X-ray imaging unit or time when the driving unit has not performed driving for a predetermined time or more;
a memory configured to store the positions of the holding device and the bed detected by the position detector in a time series;
an operation unit configured to selects positions of the holding device and the bed stored in a time-series sequence or in a reverse time-series sequence; and
a controller configured to, based on instructions from the operation unit, read out the detection results from the memory and drives the driving unit based on the detection results.

2. An X-ray imaging system comprising a holding device that holds an X-ray imaging unit that performs X-ray imaging of a subject, a bed on which the subject is placed, and a driving unit that moves the holding device and the bed, further comprising:
a position detector configured to detect the positions of the holding device and the bed in time when X-ray imaging is performed by the X-ray imaging unit;
a memory configured to associate and store detection results from the position detector with identifiers;
an operation unit; and
a controller configured to, based on instructions from the operation unit, read out the detection results from the memory and drive the driving unit based on the detection results.

3. The X-ray imaging system according to claim 2, wherein
the identifiers can be sequenced, and
the operation unit comprises:
a first switch configured to instruct the controller to read out detection results stored in the memory in the sequence corresponding to the identifiers and perform control to drive the driving unit based on the detection results; and
a second switch configured to instruct the controller to read out detection results stored in the memory in the reverse sequence of the sequence corresponding to the identifiers and perform control to drive the driving unit based on the detection results.

4. The X-ray imaging system according claim 1, wherein the memory associates and stores X-ray images of the subject obtained from the X-ray imaging unit with detection results detected by the position detector with the X-ray images captured.

5. The X-ray imaging system according to claim 2, wherein the memory associates and stores X-ray images of the subject obtained from the X-ray imaging unit with detection results detected by the position detector with the X-ray images captured.

6. The X-ray imaging system according to claim 3, wherein the memory associates and stores X-ray images of the subject obtained from the X-ray imaging unit with detection results detected by the position detector with the X-ray images captured.
